(19) United States
(12) Patent Application Publication
(10) Pub. No.: US 2025/0039743 A1
(43) Pub. Date: Jan. 30, 2025

(54) WLAN ARCHITECTURE FOR UHR NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei City (TW)

(21) Appl. No.: 18/771,922

(22) Filed: Jul. 12, 2024

Related U.S. Application Data
(60) Provisional application No. 63/529,593, filed on Jul. 28, 2023.

(51) Int. Cl. H04W 28/18; H04L 5/00; H04W 72/0446

(52) U.S. Cl. CPC H04W 28/18; H04L 5/0048; H04W 72/0446

(57) ABSTRACT

Methods and apparatuses that facilitate relaying information between source and destination devices in a wireless local area network (WLAN). A wireless communication relay device comprises a transceiver and a processor operably connected to the transceiver. The transceiver is configured to receive, from a first wireless communication device, a first frame. The processor is configured to determine that the first frame is destined for a second wireless communication device. The transceiver is further configured to transmit, to the second wireless communication device, a second frame based on the first frame. The relay device, the first wireless communication device, and the second wireless communication device are Institute of Electrical and Electronics Engineers (IEEE) 802.11 devices.

CROSS-REFERENCE TO RELATED APPLICATION AND CLAIM OF PRIORITY

This application claims priority under 35 U.S.C. § 119(e) to U.S. Provisional Patent Application No. 63/529,593 filed on Jul. 28, 2023, which is hereby incorporated by reference in its entirety.

### TECHNICAL FIELD

This disclosure relates generally to operations for communicating between source and destination nodes in wireless communications systems. Embodiments of this disclosure relate to methods and apparatuses that facilitate relaying information between source and destination devices in a wireless local area network communications system.

### BACKGROUND

Wireless local area network (WLAN) technology allows devices to access the internet in the 2.4 gigahertz (GHz), 5 GHz, 6 GHZ, or 60 GHz frequency bands. WLANs are based on the Institute of Electrical and Electronic Engineers (IEEE) 802.11 standards. The IEEE 802.11family of standards aim to increase speed and reliability and to extend the operating range of wireless networks. Next generation ultra-high reliability (UHR) WI-FI systems, e.g., IEEE 802.11bn, aim to improve the reliability of WLAN communications.

Extremely high throughput (EHT) WI-FI systems, e.g., IEEE 802.11be, introduced support for multiple bands of operation, called links, over which an access point (AP) and a non-AP device can communicate with each other. Thus, both the AP and non-AP device may be capable of communicating on different bands/links, which is referred to as multi-link operation (MLO). The WI-FI (wireless fidelity) devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

The ultra-high reliability study group (UHR SG) which is the study group for next generation WI-FI standards design (IEEE 802.11bn) has set a number of objectives for next generation WI-FI network design. The group intends to achieve the ultra-high reliability target by reducing latencies to ultra-low values, increasing throughputs at different signal-to-noise ratio (SNR) levels, enhancing power savings, etc.

### SUMMARY

Embodiments of the present disclosure provide methods and apparatuses that facilitate relaying information between source and destination devices in a WLAN.

In one embodiment, a wireless communication relay device comprises a transceiver and a processor operably connected to the transceiver. The transceiver is configured to receive, from a first wireless communication device, a first frame. The processor is configured to determine that the first frame is destined for a second wireless communication device. The transceiver is further configured to transmit, to the second wireless communication device, a second frame based on the first frame. The relay device, the first wireless communication device, and the second wireless communication device are IEEE 802.11 devices.

In another embodiment, a method performed by a wireless communication relay device comprises the steps of receiving, from a first wireless communication device, a first frame, determining that the first frame is destined for a second wireless communication device, and transmitting, to the second wireless communication device, a second frame based on the first frame. The relay device, the first wireless communication device, and the second wireless communication device are IEEE 802.11 devices.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example infrastructure network in a WLAN system according to embodiments of the present disclosure;

FIG. 4 illustrates an example infrastructure network in a WLAN system in which STAs suffer from low signal strength according to embodiments of the present disclosure;

FIG. 5 illustrates an example diagram of relay node operation according to embodiments of the present disclosure;

FIG. 6 illustrates an example diagram of relay node operation between two AP nodes according to embodiments of the present disclosure;

FIG. 7 illustrates an example diagram of relay node operation between two non-AP STA nodes according to embodiments of the present disclosure;

FIG. 8 illustrates an example diagram of two relay node operations according to embodiments of the present disclosure;

FIG. 9 illustrates an example diagram of relay node operations involving a device having dedicated relay functionality according to embodiments of the present disclosure;

FIG. 10 illustrates an example diagram of relay node operation by an AP having relay node functionality according to embodiments of the present disclosure;

FIG. 11 illustrates an example diagram of relay node operation by a non-AP STA having relay node functionality according to embodiments of the present disclosure;

FIG. 12 illustrates an example timing diagram of frame delivery through a relay node using a single NAV according to embodiments of the present disclosure;

FIG. 13 illustrates an example timing diagram of frame delivery through a relay node using separate NAVs for each hop of the relay transmission according to embodiments of the present disclosure; and

FIG. 14 illustrates an example process for facilitating relaying information between source and destination devices in a WLAN according to various embodiments of the present disclosure.

### DETAILED DESCRIPTION

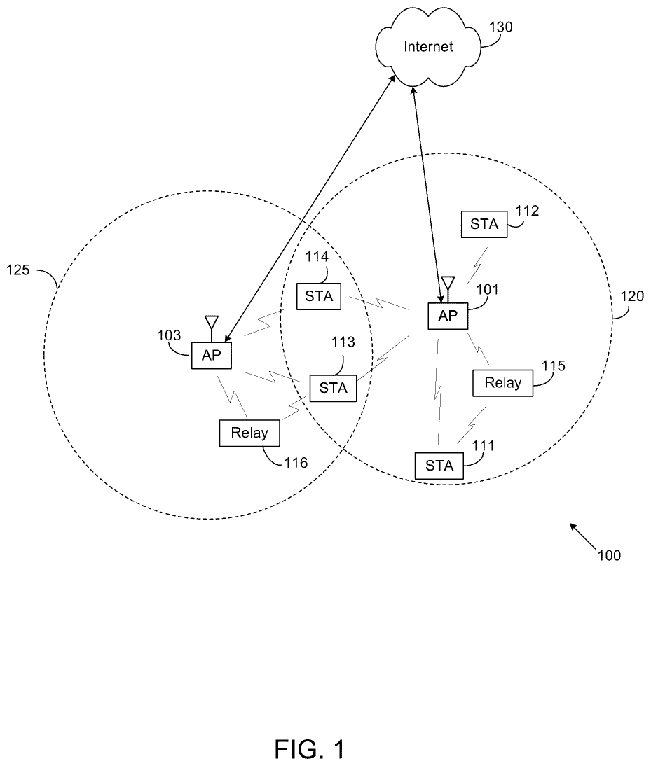

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that, in a WLAN system, communication between an AP and any of its associated non-AP STAs takes place over the link between the AP and the associated STA. That is, frame transmission/reception happens directly between the AP and the STA. If a STA is located far away from its associated AP (for example, the STA can be in the cell edge), or if the direct path between the AP and the STA is degraded for some other reason, then the direct path between the AP and the STA may be unable to achieve sufficient signal strength (e.g., having low signal-to-noise ratio (SNR) or low received signal strength indicator (RSSI) measurements) to ensure the required quality of service (QOS).

Accordingly, embodiments of the present disclosure provide procedures and devices that facilitate relaying information between source and destination devices in a WLAN, thereby increasing the functional signal strength of STAs that are suffering from low signal strength in order to improve their throughput and rate, and thus improve their reliability. In particular, embodiments of the present disclosure include an intermediate node-referred to as a relay node-that can be placed between a source node (e.g., an AP) and a destination node (e.g., a STA) and that can relay frames and physical layer protocol data units (PPDUs) from the source node to the destination node.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using WI-FI or other WLAN communication techniques. The wireless network 100 may also include relays 115 and 116. The relays 115 and 116 may communicate with any of the APs 101 and 103 and STAs 111-114 using WI-FI or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

The relays 115 and 116 may serve as an intermediate node between other nodes in the network 100. For example, as illustrated in the example of FIG. 1, relay 115 may serve as an intermediate node between AP 101 and STA 112, and relay 116 may serve as an intermediate node between AP 103 and STA 113. As discussed further below, relays 115 and 116 may be APs, STAs, or another suitable device that is able to communicate with APs and STAs.

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

Although FIG. 1 illustrates one example of a wireless network 100, various changes may be made to FIG. 1. For example, the wireless network 100 could include any number of APs, any number of STAs, and any number of relays in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

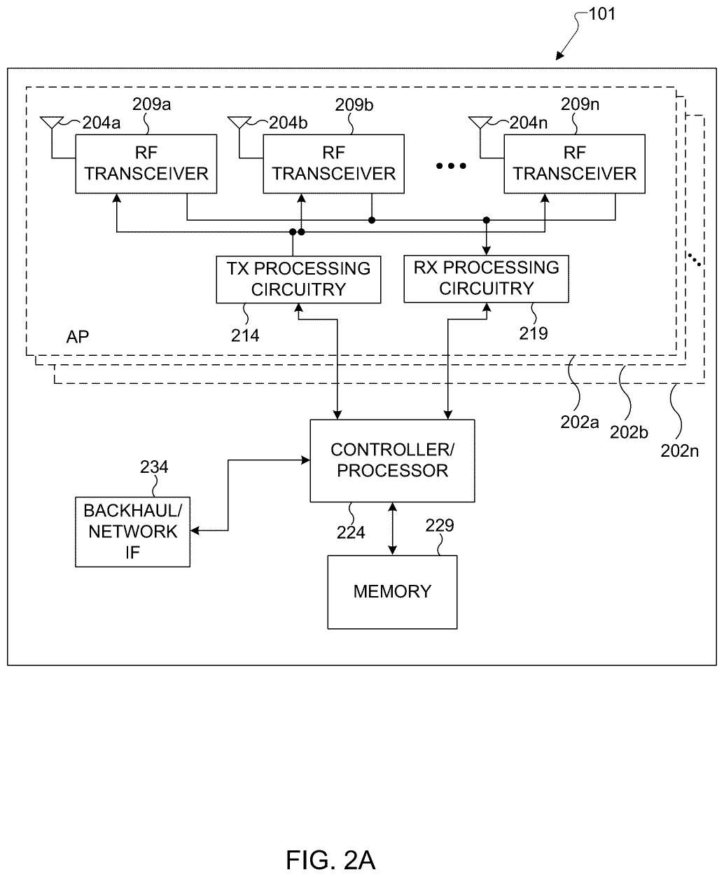

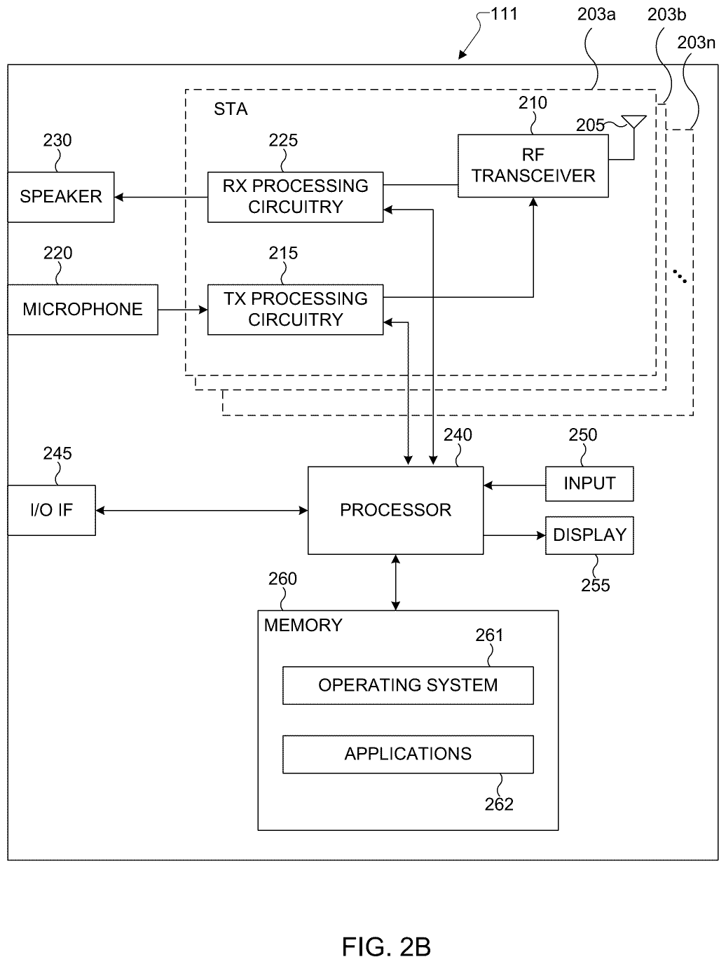

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). The controller/processor 224 could also facilitate relaying information between source and destination devices in a WLAN. Any of a wide variety of other functions could be supported in the AP MLD 101 by the controller/processor 224. In some embodiments, the controller/processor 224 includes at least one microprocessor or microcontroller. The controller/processor 224 is also capable of executing programs and other processes resident in the memory 229, such as operations for facilitating relaying information between source and destination devices in a WLAN. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-114 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate relaying information between source and destination devices in a WLAN. In some embodiments, the controller/processor 240 includes at least one microprocessor or microcontroller.

The controller/processor 240 is also capable of executing other processes and programs resident in the memory 260, such as operations for facilitating relaying information between source and destination devices in a WLAN. The controller/processor 240 can move data into or out of the memory 260 as required by an executing process. In some embodiments, the controller/processor 240 is configured to execute a plurality of applications 262, such as applications for facilitating relaying information between source and destination devices in a WLAN. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

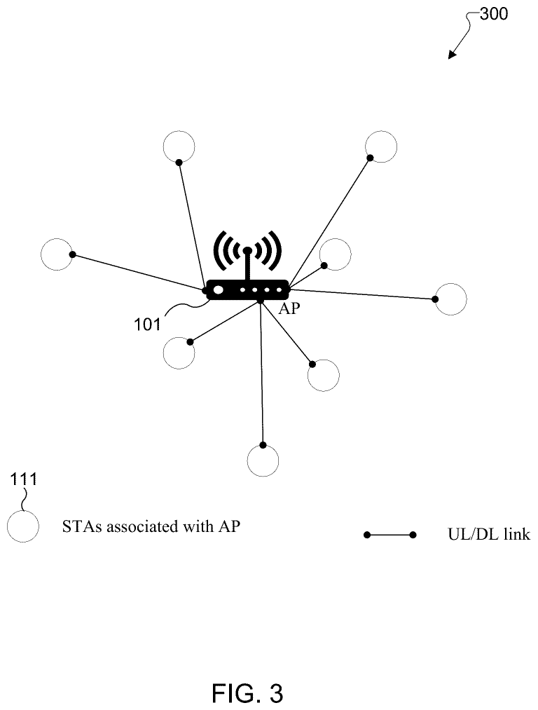

FIG. 3 illustrates an example infrastructure network 300 in a WLAN system according to embodiments of the present disclosure. In the example of FIG. 3, the AP may be one of WI-FI APs 101 and 103, and the STAs associated with the AP may each be one of WI-FI STAs 111-114. It is understood, however, that the AP may be an AP MLD or any other suitable device and the STAs may be non-AP MLDs or any other suitable device. For simplicity, it is understood that further references to an AP herein below may refer to an AP or AP MLD 101 or 103, and further references to a STA herein below may refer to a STA or non-AP MLD 111-114.

As noted above and as illustrated in FIG. 3, in a WLAN system, communication between an AP and any of its associated non-AP STAs takes place over the link between the AP and the associated STA. That is, frame transmission/reception happens directly between the AP and the STA. In a WLAN network, if a STA is located far away from its associated AP (for example, the STA can be in the cell edge), or if the direct path between the AP and the STA is degraded for some other reason, then the direct path between the AP and the STA may be unable to achieve sufficient signal strength (e.g., having low signal-to-noise ratio (SNR) or low received signal strength indicator (RSSI) measurements) to ensure the required quality of service (QoS).

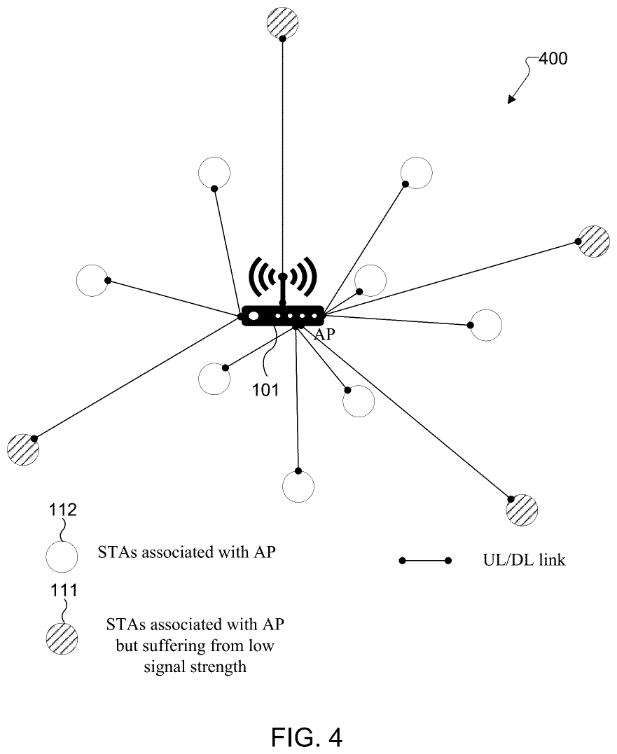

FIG. 4 illustrates an example infrastructure network 400 in a WLAN system in which STAs suffer from low signal strength according to embodiments of the present disclosure. As illustrated in FIG. 4, some of the STAs may have a link to the AP but for some reason suffer a low signal strength on that link. These STAs may be unable to maintain the QoS that is required of them (e.g., for UHR operations) on the link to the AP.

Accordingly, various embodiments of the present disclosure provide mechanisms to increase the functional signal strength of STAs that are suffering from low signal strength in order to improve their throughput and rate, and thus improve their reliability. This may be particularly helpful for cell-edge users.

According to various embodiments, an intermediate node can be placed between a source node (e.g., an AP) and a destination node (e.g., a STA) and that can relay frames and PPDUs from the source node to the destination node. Such an intermediate node can be referred to as a relay node.

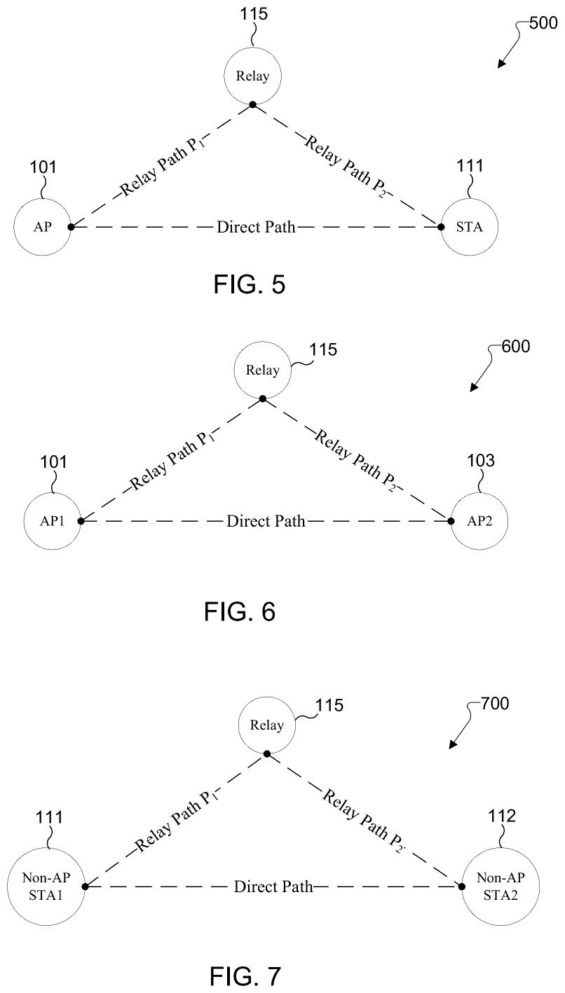

FIG. 5 illustrates an example diagram 500 of relay node operation according to embodiments of the present disclosure. In the example of FIG. 5, the STA is associated with the AP. However, the signal strength over the direct path between the AP and the STA is poor (either due to distance or some other cause of interference). A relay node (e.g., relay node 115) is therefore placed between the AP and the STA. The AP and the STA are able to communicate with each other through the relay node.

For example, if the AP intends to transmit a PPDU to the STA, the AP can transmit the PPDU to the relay node first over the Relay Path P₁, and then the relay node can forward the PPDU to the STA over the Relay Path P₂. Similarly, if the STA intends to transmit a PPDU to the AP, the STA can send the PPDU to the relay node first over the Relay Path P₂, and then the relay node can forward the PPDU to the AP over the Relay Path P₁.

According to one embodiment, when a relay node receives a frame from a source node, and the frame is destined for a destination node, the relay node can take one of the following actions for forwarding the frame to the destination node. The relay node, upon receiving the frame from the source node, can simply forward the frame to the destination node without making any changes to the frame. Alternatively, the relay node, upon receiving the frame from the source node, can amplify the power of the frame and then transmit the frame to the destination node. Alternatively, the relay node, upon receiving the frame from the source node, can decode the frame and then transmit the decoded information or part of the decoded information to the destination node.

According to one embodiment, a relay node can relay frames between any type of source node STA and any type of destination node STA. That is, the source node can be either an AP or a non-AP STA and the destination node can be either an AP or a non-AP STA.

FIG. 6 illustrates an example diagram 600 of relay node operation between two AP nodes according to embodiments of the present disclosure. The functionality of the relay node in the example of FIG. 6 may be the same as that in FIG. 5.

FIG. 7 illustrates an example diagram 700 of relay node operation between two non-AP STA nodes according to embodiments of the present disclosure. The functionality of the relay node in the example of FIG. 7 may be the same as that in FIG. 5.

According to one embodiment, there can be more than one relay node operating between a source node and a destination node. In the case in which there are multiple relay nodes between the source node and the destination node, there can be multiple hops before a frame or PPDU from the source node is delivered to the destination node.

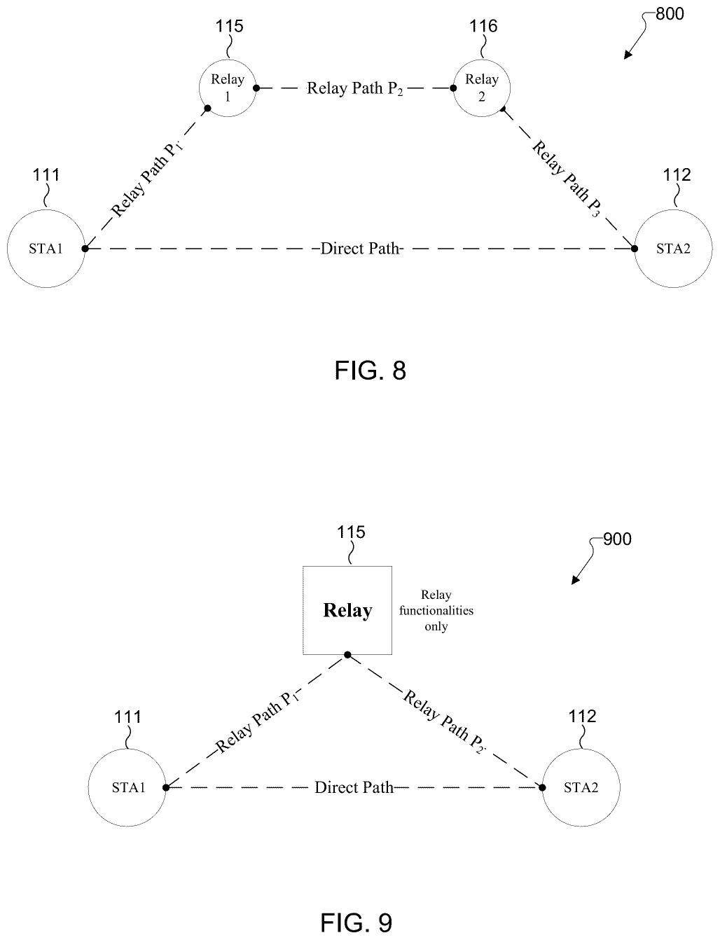

FIG. 8 illustrates an example diagram 800 of two relay node operations according to embodiments of the present disclosure. In this example, if STA1 intends to transmit a PPDU to STA2, then STA1 can transmit the PPDU to relay node 1 first over the Relay Path P₁, relay node 1 can forward the PPDU to relay node 2 over the Relay Path P₂, and then relay node 2 can forward the PPDU to STA2 over the Relay Path P₃. Similarly, if STA2 intends to transmit a PPDU to STA1, then STA2 can send the PPDU to relay node 2 first over the Relay Path P₃, relay node 2 can forward the PPDU to relay node 1 over the Relay Path P₂, and then relay node 1 can forward the PPDU to STA1 over the Relay Path P₁.

According to one embodiment, a relay node can be a new device type. According to this embodiment, the relay node's main functionality is to receive a PPDU from the source node and forward it to the destination node. The relay node may not have any AP-like functionalities or non-AP STA-like functionalities in this case.

FIG. 9 illustrates an example diagram 900 of relay node operations involving a device having dedicated relay functionality according to embodiments of the present disclosure. The relay node 115 in this example may be a purpose-fit device that does not have any AP-like functionalities or non-AP STA-like functionalities.

According to one embodiment, a relay node can have AP functionalities. According to this embodiment, a relay engine that would contain the relay functionalities may reside within an AP framework.

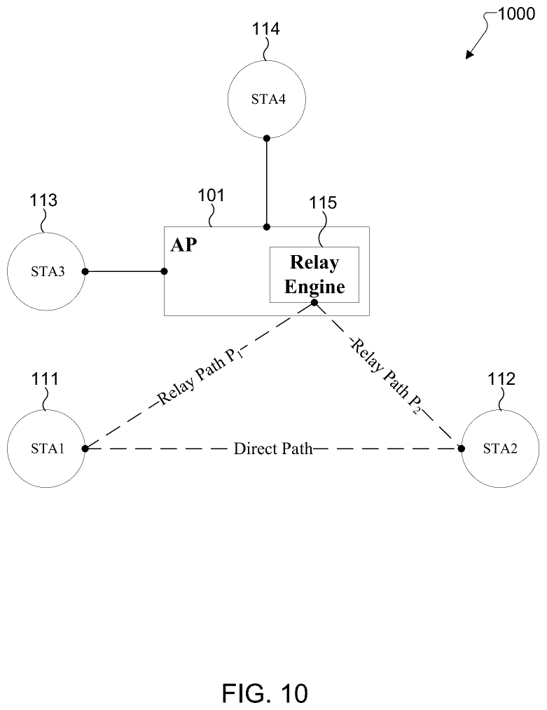

FIG. 10 illustrates an example diagram 1000 of relay node operation by an AP having relay node functionality according to embodiments of the present disclosure. In this example the relay engine may have all of the features of the relay node 115 within an AP. The relay engine may use the existing hardware of the AP to implement the functionality of the relay node 115. In this example, STA1 and STA2 are taking advantage of the relay functionalities of the AP. STA3 and STA4 are not using the relay functionalities but are associated with the AP.

According to one embodiment, a relay node can have non-AP STA functionalities. According to this embodiment, a relay engine that would contain the relay functionalities may reside within a non-AP STA framework.

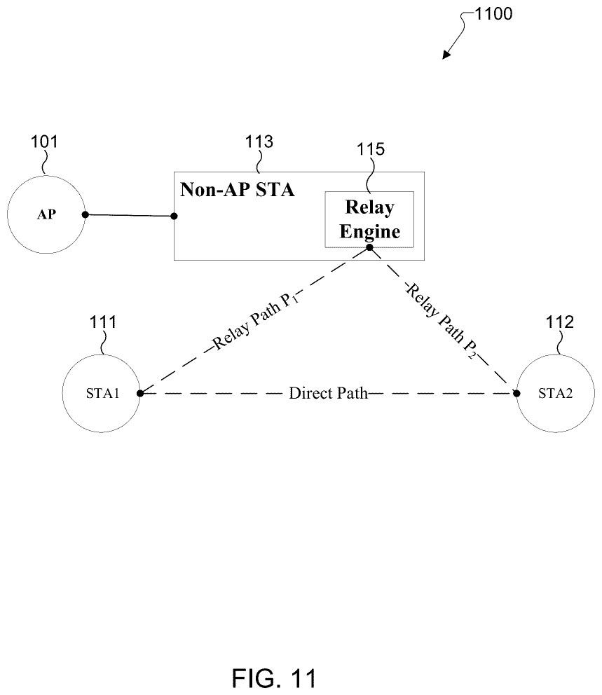

FIG. 11 illustrates an example diagram 1100 of relay node operation by a non-AP STA having relay node functionality according to embodiments of the present disclosure. In this example the relay engine may have all of the features of the relay node 115 within a non-AP STA. The relay engine may use the existing hardware of the STA to implement the functionality of the relay node 115. The non-AP STA 113 in the example is associated with the AP using the non-AP STA functionalities of the non-AP STA node 113.

According to one embodiment, when a source node intends to utilize a relay node for forwarding frames to a destination node, there is a negotiation or agreement between the source node and the relay node beforehand. According to another embodiment, in order to exchange frame between a source node and a destination node through a relay node, both the source node and the destination node need to have an agreement/negotiation/setup with the relay node before the relaying operation can take place. According to another embodiment, neither a source node nor a destination node need to have any agreement/negotiation/setup with a relay node in order to exchange frames between the source node and the destination node through the relay node.

According to one embodiment, the relaying operation can be transparent to the destination node. That is, when a destination node receives a frame from a relay node, the destination node treats the frame as if it is receiving the frame from the source node.

According to one embodiment, if a source node transmits a frame to the relay node and the frame is destined for a destination node, then the source node sets up the network allocation vector (NAV) based on the time needed to deliver the frame from the source node to the relay node, the time needed by the relay node to process the frame, and the time needed to deliver the frame from the relay node to the destination node.

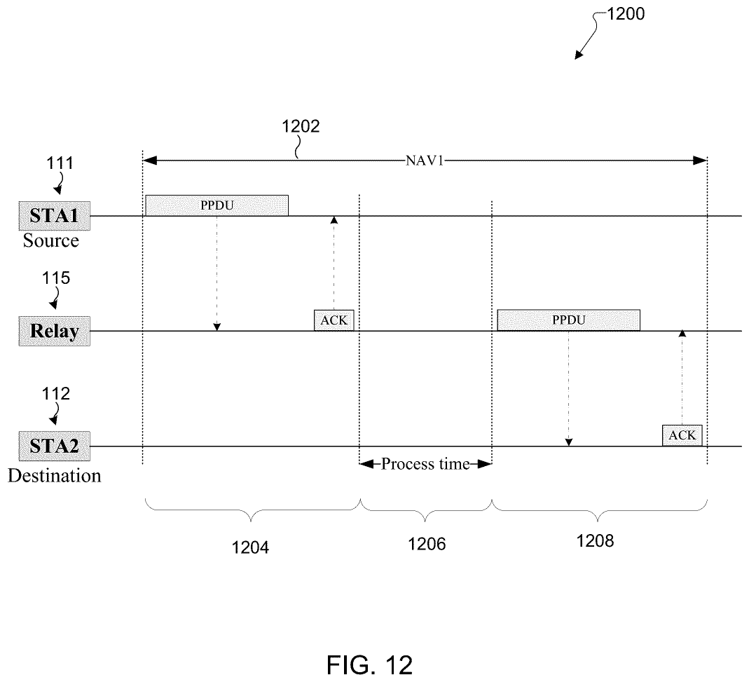

FIG. 12 illustrates an example timing diagram 1200 of frame delivery through a relay node using a single NAV according to embodiments of the present disclosure. As shown in FIG. 12, the source node (STA1) sets up the NAV 1202 based on the time 1204 needed to deliver the frame from the source node to the relay node, the time 1206 needed by the relay node to process the frame, and the time 1208 needed to deliver the frame from the relay node to the destination node (STA2).

According to one embodiment, if a source node transmits a frame to the relay node and the frame is destined for a destination node, then the source node sets up the NAV based on only the time needed to deliver the frame from the source node to the relay node. The relay node then, before forwarding the frame to the destination node, sets the NAV based on the time needed to deliver the frame from the relay node to the destination node.

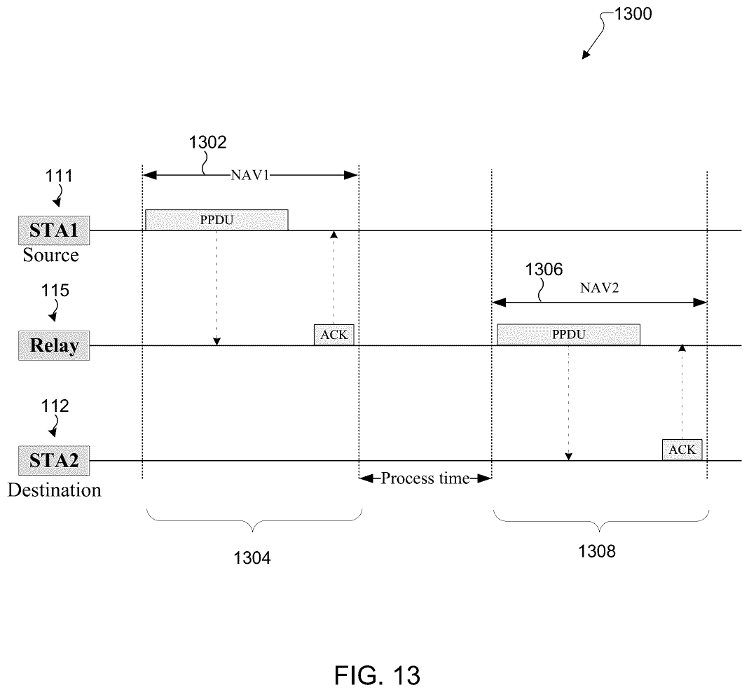

FIG. 13 illustrates an example timing diagram 1300 of frame delivery through a relay node using separate NAVs for each hop of the relay transmission according to embodiments of the present disclosure. As shown in FIG. 13, the source node (STA1) sets up the NAV 1302 based on the time 1304 needed to deliver the frame from the source node to the relay node. The relay node then processes the frame, and sets up the NAV 1306 based on the time 1308 needed to deliver the frame from the relay node to the destination node (STA2).

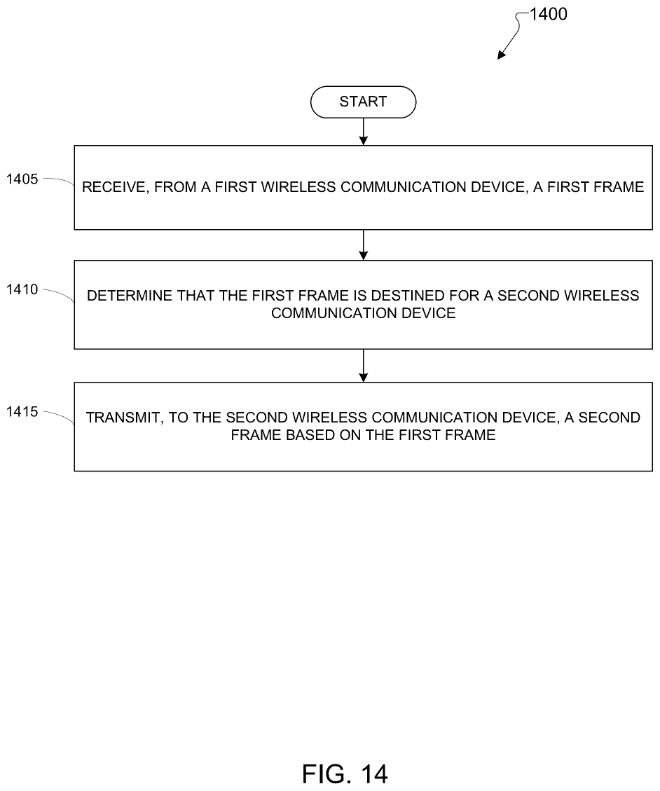

FIG. 14 illustrates an example process 1400 for facilitating relaying information between source and destination devices in a WLAN according to various embodiments of the present disclosure. The process 1400 of FIG. 14 is discussed as being performed by a first wireless communication relay device (in particular an AP, a non-AP STA, or a standalone relay device), but it is understood that corresponding source and destination devices (in particular an AP or a non-AP STA) perform a corresponding process.

Referring to FIG. 14, at step 1405 the relay device receives, from a first wireless communication device, a first frame.

Next, the relay device determines that the first frame is destined for a second wireless communication device (step 1410). In some embodiments, the relay device, the first wireless communication device, and the second wireless communication device are IEEE 802.11 devices (i.e., WI-FI devices).

Then, the relay device transmits, to the second wireless communication device, a second frame based on the first frame (step 1415). In some embodiments, the second frame is the first frame-that is, the relay device forwards the first frame to the second device at step 1415. In some embodiments, before step 1415 the relay device additionally decodes the first frame to obtain first information and generates the second frame to include at least part of the first information.

In some embodiments, the first wireless communication device is one of an AP or a non-AP STA, and the second wireless communication device is also one of an AP or a non-AP STA. That is, the first wireless communication device is a source device, and the second wireless communication device is a destination device. In other embodiments, one or both of the first wireless communication device and the second wireless communication device is another relay device.

In some embodiments, the relay device is an AP or a non-AP STA. In other embodiments, the relay device is a standalone relay device that does not function as an AP or non-AP STA.

In some embodiments, before step 1405 (i.e., before receiving the first frame) the relay device establishes an agreement with the first wireless communication device to forward frames on behalf of the first wireless communication device. In such embodiments, the first wireless communication device may be a source device (e.g., an AP or non-AP STA). In some such embodiments, the relay device additionally establishes a second agreement with the second wireless communication device to relay frames to the second wireless communication device. In such embodiments, the second wireless communication device may be a destination device (e.g., an AP or non-AP STA).

In some embodiments, a NAV corresponding to the first frame is set by the first wireless communication device to account for a total time from commencement of the transmission of the first frame to completion of the transmission of the second frame. In other embodiments, a first NAV corresponding to the first frame is set by the first wireless communication device to account for a time to completion of the transmission of the first frame, and the relay device, before step 1415, sets a second NAV corresponding to the second frame to account for a time to completion of the transmission of the second frame.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A wireless communication relay device comprising:
a transceiver configured to receive, from a first wireless communication device, a first frame; and
a processor operably connected to the transceiver and configured to determine that the first frame is destined for a second wireless communication device,
wherein the transceiver is further configured to transmit, to the second wireless communication device, a second frame based on the first frame, and
wherein the relay device, the first wireless communication device, and the second wireless communication device are Institute of Electrical and Electronics Engineers (IEEE) 802.11 devices.

2. The relay device of claim 1, wherein the second frame is the first frame.

3. The relay device of claim 1, wherein the processor is further configured to:
decode the first frame to obtain first information; and
generate the second frame to include at least part of the first information.

4. The relay device of claim 1, wherein:
the first wireless communication device is one of an access point (AP) or a non-AP station (STA), and
the second wireless communication device is one of an AP or a non-AP STA.

5. The relay device of claim 1, wherein one or both of the first wireless communication device and the second wireless communication device is another relay device.

6. The relay device of claim 1, wherein the relay device is an AP or a non-AP STA.

7. The relay device of claim 1, wherein the processor is further configured to, before receiving the first frame, establish an agreement with the first wireless communication device to forward frames on behalf of the first wireless communication device.

8. The relay device of claim 1, wherein the processor is further configured to:
before receiving the first frame, establish a first agreement with the first wireless communication device to relay frames on behalf of the first wireless communication device, and
before receiving the first frame, establish a second agreement with the second wireless communication device to relay frames to the second wireless communication device.

9. The relay device of claim 1, wherein a network allocation vector (NAV) corresponding to the first frame is set by the first wireless communication device to account for a total time from commencement of the transmission of the first frame to completion of the transmission of the second frame.

10. The relay device of claim 1, wherein:
a first NAV corresponding to the first frame is set by the first wireless communication device to account for a time to completion of the transmission of the first frame, and
the processor is further configured to set a second NAV corresponding to the second frame to account for a time to completion of the transmission of the second frame.

11. A method performed by a wireless communication relay device, the method comprising:
receiving, from a first wireless communication device, a first frame;
determining that the first frame is destined for a second wireless communication device;
and transmitting, to the second wireless communication device, a second frame based on the first frame,
wherein the relay device, the first wireless communication device, and the second wireless communication device are Institute of Electrical and Electronics Engineers (IEEE) 802.11 devices.

12. The method of claim 11, wherein the second frame is the first frame.

13. The method of claim 11, further comprising:
decoding the first frame to obtain first information; and
generating the second frame to include at least part of the first information.

14. The method of claim 11, wherein:
the first wireless communication device is one of an access point (AP) or a non-AP station (STA), and
the second wireless communication device is one of an AP or a non-AP STA.

15. The method of claim 11, wherein one or both of the first wireless communication device and the second wireless communication device is another relay device.

16. The method of claim 11, wherein the relay device is an AP or a non-AP STA.

17. The method of claim 11, further comprising:
before receiving the first frame, establishing an agreement with the first wireless communication device to forward frames on behalf of the first wireless communication device.

18. The method of claim 11, further comprising:
before receiving the first frame, establishing a first agreement with the first wireless communication device to relay frames on behalf of the first wireless communication device; and
before receiving the first frame, establishing a second agreement with the second wireless communication device to relay frames to the second wireless communication device.

19. The method of claim 11, wherein a network allocation vector (NAV) corresponding to the first frame is set by the first wireless communication device to account for a total time from commencement of the transmission of the first frame to completion of the transmission of the second frame.

20. The method of claim 11, wherein:
a first NAV corresponding to the first frame is set by the first wireless communication device to account for a time to completion of the transmission of the first frame, and
the method further comprises setting a second NAV corresponding to the second frame to account for a time to completion of the transmission of the second frame.
